(19) United States
(12) Patent Application Publication
(10) Pub. No.: US 2024/0426453 A1
(43) Pub. Date: Dec. 26, 2024

(54) VEHICLE LIGHTING DEVICE COMPRISING A TRANSLUCENT SUBSTRATE AND A MASK, AND ASSOCIATED MANUFACTURING METHOD

(71) Applicant: Flex-N-Gate France, AUDINCOURT (FR)

(72) Inventors: Thierry RECEVEUR, VILLARS LES BLAMONT (FR); Léa DOS SANTOS, MONTBELIARD (FR); Stéphanie BERGERAT, AUDINCOURT (FR); Olivier PUJOL, BELFORT (FR)

(21) Appl. No.: 18/750,715

(22) Filed: Jun. 21, 2024

(30) Foreign Application Priority Data
Jun. 21, 2023 (FR) FR 23 06414

(51) Int. Cl. F21S 43/20; F21S 43/14; F21V 3/02; F21V 3/06; F21V 3/10; F21W 103/20; F21W 103/55; F21W 103/60; F21Y 115/10

(52) U.S. Cl. CPC F21S 43/265; F21S 43/14; F21V 3/02; F21V 3/062; F21V 3/10; F21W 2103/20; F21W 2103/55; F21W 2103/60; F21Y 2115/10

(57) ABSTRACT

A light device having a translucent substrate, a mask overlying the substrate, and a light source. The mask includes an appearance layer and an opacifying layer. The mask has a plurality of holes passing through the opacifying layer to allow light to pass through the mask when the light source is switched on, each hole has a diameter less than 0.40 mm, the holes being distributed so as to jointly form a light pattern when the light source is switched on.

### TECHNICAL FIELD

The present invention relates to the field of vehicle lighting devices, in particular for a motor vehicle.

### BACKGROUND

It is possible to provide a lighting device comprising a translucent substrate covered by a mask delimiting through apertures allowing the passage of light generated by a light source located behind the translucent substrate.

The lighting device is, for example, a daytime running light fixed to the front of the vehicle. This device allows the driver of the vehicle to be better seen by other road users during the day in normal traffic conditions.

Alternatively, the lighting device is a position light enabling the vehicle driver to signal his presence to other road users at night or when visibility conditions are poor (rain, fog, poorly lit roads, etc.).

Alternatively, the lighting device is a flashing light enabling the driver of the vehicle to indicate his intention to change direction to other road users.

Alternatively, the lighting device is part of a man-machine interface system. In this case, its function is to display information, for example in the form of one or more light patterns.

Alternatively, the lighting device is a companion light or an embellishment light used to give the vehicle a distinctive signature.

### SUMMARY

One of the aims of the invention is to offer a luminous device that forms a contrasting and homogeneous light pattern, the luminous device being very discreet and even virtually invisible to the user in the absence of backlighting.

To this end, the invention proposes a vehicle lighting device comprising a translucent substrate, a mask covering the substrate, the mask comprising an appearance layer and an opacifying layer, and a light source, the mask having a plurality of holes passing through the opacifying layer to allow the passage of light through the mask when the light source is switched on, each hole having a diameter equal to or less than 0.40 mm, the holes being distributed so as to jointly form a light pattern when the light source is switched on.

The plurality of small, spaced-apart holes makes it possible to define a light pattern formed by a plurality of distinct, spaced-apart light points, each light point corresponding to a respective hole in the opacifying layer.

Each hole is difficult for a user to detect when the light source is switched off. Together, the holes form a high-contrast, even light pattern when the light source is switched on.

In particular embodiments, the lighting device further comprises one or more of the following optional features, taken individually or in any technically possible combinations:
the light pattern is formed by at least 50 holes, in particular at least 100 holes;
each hole has a diameter equal to or less than 0.30 mm, in particular equal to or less than 0.20 mm, preferably equal to or less than 0.15 mm, even more preferably equal to or less than 0.10 mm;
the distance between each hole and each other hole is, for example, equal to or greater than 0.20 mm;
the distance between each hole and at least one other hole is equal to or less than 0.50 mm, in particular equal to and/or less than 0.40 mm;
the mask covers an inner surface of the substrate;
the mask covers an external surface of the substrate;
the appearance layer is located in front of the opacifying layer;
the holes extend through the appearance layer;
the appearance layer is coloured paint;
the opacifying layer is opacifying paint.

The invention also relates to a method of manufacturing a luminous device as defined above, comprising obtaining a substrate, applying the appearance layer and the opacifying layer to the substrate, and forming the plurality of holes in the opacifying layer, and optionally in the appearance layer, using laser pulses generated by a laser, preferably an infrared laser.

### BRIEF DESCRIPTION OF THE DRAWINGS

Other aspects and advantages of the invention will become apparent from the following description, which is given solely by way of non-limiting example, with reference to the appended drawings, including:

FIG. 1 is a schematic cross-sectional view of a lighting device;

FIG. 2 is a partial schematic front view of the lighting device shown in FIG. 1;

FIG. 3 is a schematic cross-sectional view of a lighting device in one variant;

FIG. 4 shows schematically the stages in the manufacture of the luminous device shown in FIG. 1;

FIG. 5 shows a schematic diagram of the steps involved in manufacturing the lighting device shown in FIG. 3.

### DETAILED DESCRIPTION

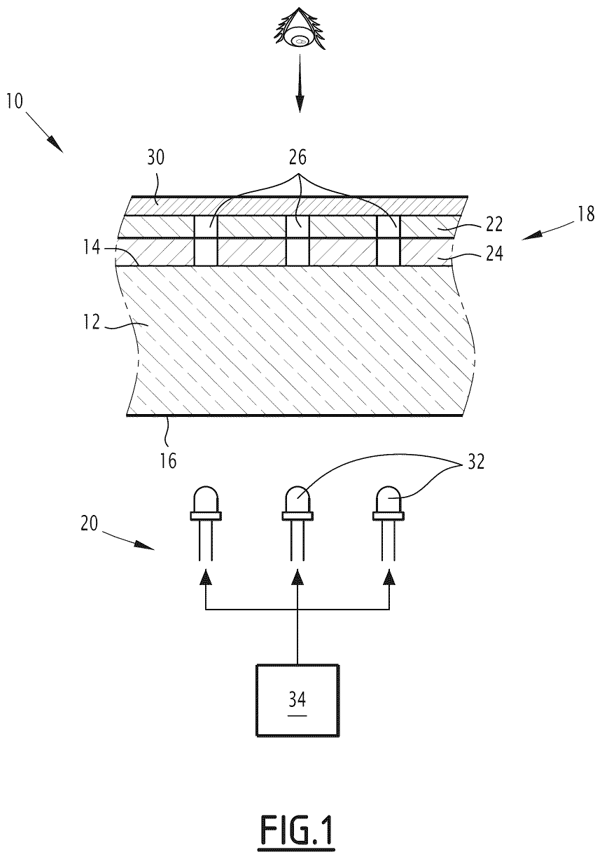

FIG. 1 shows a schematic cross-section of a lighting device 10 for a vehicle.

The lighting device 10 comprises a translucent substrate 12 comprising an outer surface 14 and an inner surface 16, a mask 18 covering the substrate 12 and a light source 20 disposed behind the substrate 12, i.e. on the side of the inner surface 16 of the substrate 12.

The external surface 14 is intended to be visible. The outer surface 14 faces away from the lighting device 10.

The inner surface 16 faces away from the outer surface 14. The inner surface 16 faces the inside of the lighting device 10.

In the following description, the term “translucent” refers to a light-transmitting body, i.e. one with a light transmission rate of between 5% and 100%.

The term “transparent” refers to a body that transmits light and through which objects can be seen clearly, i.e. a body with a light transmission rate greater than 90%, for example close to or equal to 100%.

The terms “opaque” and “opacifying” designate a body that allows little or no light to pass through, i.e. a body with a light transmission rate of less than 5%, or even close to or equal to 0%.

Light is considered to be in the visible range, i.e. composed of electromagnetic waves with wavelengths generally between 380 nm and 780 nm.

The luminous device 10 is, for example, a lighting and/or signalling device.

The vehicle is, for example, a motor vehicle, such as a car, lorry, bus or similar.

When the luminous device 10 is a lighting and/or signalling device, the substrate 12 is also called an “ice light”.

The outer surface 14 and the inner surface 16 of the substrate 12 are locally substantially parallel to each other. In other words, the thickness of the substrate 12 is substantially constant.

The thickness of the substrate 12 is, for example, between 2 mm and 5 mm.

Advantageously, the thickness of the substrate 12 is between 2 mm and 3 mm, for example 2 mm.

This limits the optical distortion of the light pattern created by the mask 18, particularly when the light pattern is created through the substrate 12.

The substrate 12 is preferably made of plastic.

Advantageously, the substrate 12 is made of polycarbonate or PMMA.

This results in a substrate 12 with a high transmission rate, greater than 90%, i.e. a transparent substrate 12.

Using a substrate 12 makes it possible to obtain a luminous device 10 with a powerful luminous intensity while limiting power consumption.

In addition, polycarbonate and PMMA both have very good mechanical strength and good sealing and appearance properties.

The mask 18 comprises an appearance layer 22 and an opacifying layer 24 arranged one on top of the other, and has a plurality of holes 26, for example of circular outline, passing through the opacifying layer 24, and possibly the appearance layer 22, the holes 26 being spaced apart from one another, each hole allowing light from the light source 20 to pass through the mask 18.

The holes 26 of the plurality of holes 26 together form a geometric pattern and/or symbol and/or text and/or design such as a brand logo.

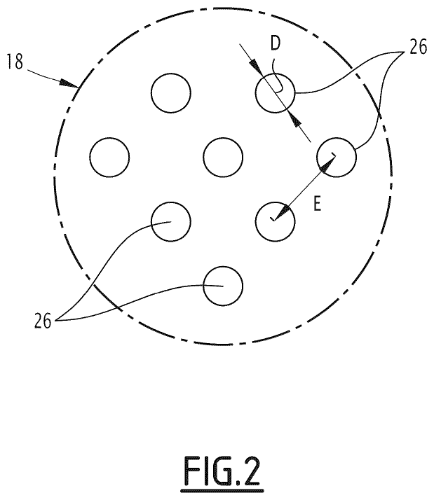

As illustrated in FIG. 2, each hole 26 has a diameter D equal to or less than 0.40 mm, preferably a diameter equal to or less than 0.30 mm, even more preferably a diameter equal to or less than 0.20 mm, even more preferably a diameter equal to or less than 0.15 mm, in particular a diameter equal to or less than 0.10 mm.

A smaller diameter D of the holes 26 allows the holes 26 to be unobtrusive when the light source 20 is switched off.

The distance E between each hole 26 and each other hole 26 is, for example, equal to or greater than 0.20 mm. In other words, the minimum distance between two holes 26 of the plurality of holes 26 is equal to or greater than 0.20 mm.

The distance E between two holes 26 is measured between the centres of these holes 26.

A minimum distance between adjacent holes 26 ensures that the holes 26 remain unobtrusive when the light source is switched off.

The distance between each hole 26 and at least one other hole 26 is equal to or less than 0.50 mm, in particular equal to and/or less than 0.40 mm. In other words, each hole 26 is at a distance from at least one other hole 26 which is equal to or less than 0.50 mm, in particular equal to and/or less than 0.40 mm.

A maximum distance between adjacent holes 26 enables a contrasting and uniform light pattern to be formed when the light source 20 is switched on.

Preferably, the holes 26 also pass through the appearance layer 22. In this case, the holes 26 pass through the mask 18.

This ensures good light transmission through the mask 18, in particular whatever the light transmission rate of the appearance layer 22.

Alternatively, the holes 26 pass through the opacifying layer 24 without passing through the appearance layer 22.

This ensures that the holes 26 remain unobtrusive when the light source is switched off. This is possible when the appearance layer 22 is translucent or transparent.

The appearance layer 22 is arranged in front of the opacifying layer 24. The appearance layer 22 is located on the outside with respect to the opacifying layer 24.

Appearance layer 22 is a coloured paint layer, for example.

The colour of the appearance layer 22 corresponds, for example, substantially to the colour of an element of the bodywork of the vehicle adjacent to the luminous device 10, such as a bumper or rear-view mirror.

The colour of the appearance layer 22 corresponds to the colour of the mask 18 as seen by the user observing the luminous device 10 from the outside and more generally to the colour of the luminous device 10 seen from the outside when the light source 20 is switched off.

The result is an assembly comprising a vehicle body element and a lighting device 10 in which the body element and the appearance layer 22 have the same colour.

The appearance layer 22 comprises, for example, a pigmentation or a compound giving a metallic or pearlescent effect.

The opacifying layer 24 is for example a layer of opacifying paint, in particular a layer of black paint.

The opacifying layer 24 ensures that the solid areas of the mask 18 are opaque and that there is no light leakage.

This improves the contrast between the regions of the substrate 12 covered by the solid areas of the mask 18 through which no light is transmitted, and the regions of the substrate 12 opposite the holes 26 through which the light from the light source 20 is transmitted.

The appearance layer 22 has a thickness of between 5 μm and 30 μm, for example 12 μm.

The opacifying layer 24 has a thickness of between 5 μm and 40 μm, for example 20 μm.

The mask 18 has a thickness of between 10 μm and 70 μm, for example 30 μm.

As shown in FIG. 1, in one example, the mask 18 covers the outer surface 14 of the substrate 12.

In this case, the opacifying layer 24 covers the outer surface 14 of the substrate 12 and the appearance layer covers the opacifying layer 24. The opacifying layer 24 is located between the substrate 12 and the appearance layer 22.

This arrangement allows forming a homogeneous, contrasting light pattern.

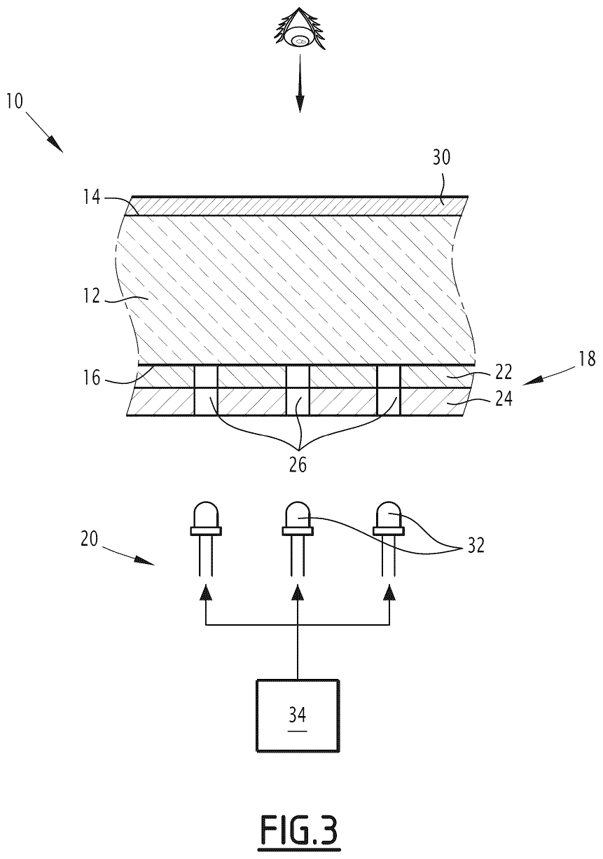

As shown in FIG. 3, in one example the mask 18 covers the inner surface 16 of the substrate 12.

In this case, the appearance layer 22 covers the inner surface 16 of the substrate 12 and the opacifying layer 24 covers the appearance layer 22. The appearance layer 22 is located between the substrate 12 and the opacifying layer 24.

This arrangement helps to protect the appearance layer 22, which is protected by the substrate 12.

Optionally, the luminous device 10 comprises a protective coating layer 30.

When the mask 18 is placed on the outer surface 14 of the substrate 12 (FIG. 1), the protective coating layer 30 covers the mask 18. The mask 18 is positioned between the protective coating layer 30 and the substrate 12.

When the mask 18 is arranged on the inner surface 16 of the substrate 12 (FIG. 3), the protective coating layer 30 is arranged on the outer surface of the substrate 12. The protective coating layer 30 and the mask 18 are arranged on either side of the substrate 12.

The protective coating layer 30 is translucent, preferably transparent.

The protective coating layer 30 allows protecting the mask 18 or the outer surface 14 of the substrate 12 against scratches, abrasion, impact, ultraviolet rays, chemicals in the surrounding air, yellowing, weathering, etc.

The protective coating layer 30 has a thickness of between 5 μm and 30 μm, for example 10 μm.

For example, the protective coating layer 30 comprises a primer layer attached, as appropriate, to the mask 18 or to the outer surface 14 of the substrate 12, and a varnish layer attached to the primer layer.

The primer allows the varnish to bond better.

Preferably, the varnish layer comprises a modified siloxane resin.

The light source 20 comprises, for example, one or more light-emitting diodes 32.

Advantageously, the luminous device 10 comprises an electronic control module 34 configured to control each light-emitting diode 32.

The electronic control module 34 makes it possible to control the switching on of each of the light-emitting diodes 32 independently of each other, the switching on of the light-emitting diodes 32 in groups of light-emitting diodes 32 and/or the switching on of all the light-emitting diodes 32.

In operation, when the light source 20 is switched off, the small holes 26 are barely visible for the user.

When the light source 20 is switched on, the light passes through the substrate 12 and then through the holes 26 in the mask 18 (FIG. 1), drawing the light pattern, or passes through the holes 26 in the mask 18 and then through the substrate 12 (FIG. 3), drawing the light pattern. The light pattern is drawn with good homogeneity and satisfactory contrast.

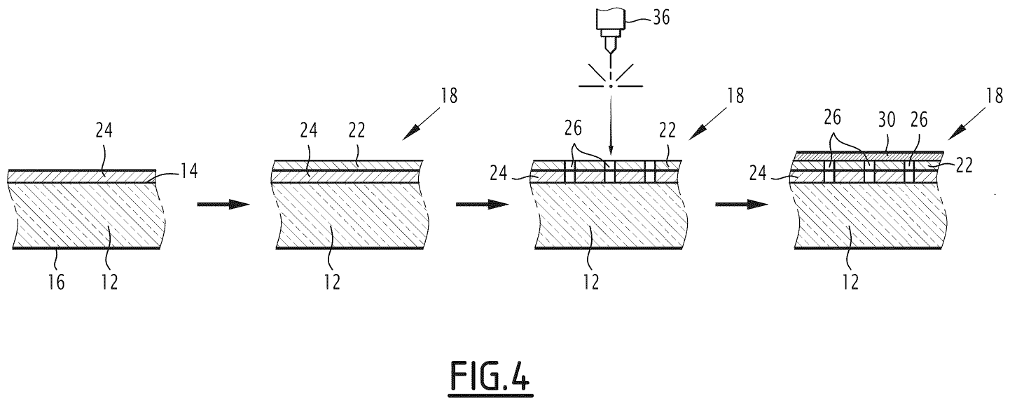

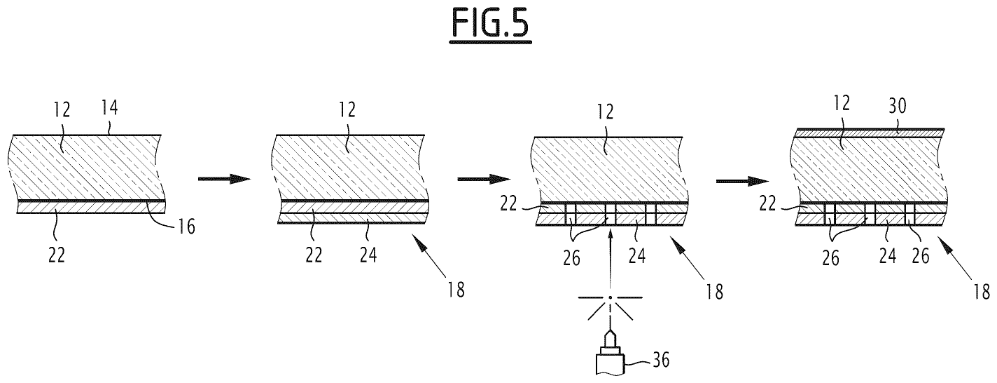

A method of manufacturing a luminous device 10 will now be described with reference to FIGS. 4 and 5.

The method of manufacturing a luminous device 10 comprises providing a substrate 12. The substrate 12 is made, for example, by injection moulding.

Preferably, substrate 12 is manufactured by injection moulding of polycarbonate or PMMA to obtain a transparent substrate 12.

The process then involves applying the mask 18 to the substrate 12.

As illustrated in FIG. 4, in the case of a mask 18 disposed on the outer surface 14 of the substrate 12, application of the mask 18 comprises, for example, application of the opacifying layer 24 to the outer surface 14 of the substrate 12, followed by application of the appearance layer 22 to the opacifying layer 24.

The manufacturing process comprises forming the holes 26, each hole 26 extending through the opacifying layer 24 and, optionally, through the appearance layer 22.

Each hole 26 is formed using laser radiation generated by a laser 36, by generating one or more laser pulses.

The use of laser radiation 56 enables holes 26 to be defined with precise dimensions with precise positioning of the holes 26, in particular relative to each other, so as to form a precise overall geometric pattern.

The laser 36 is moved relative to the substrate 12 between the formation of a previous hole 26 and the formation of a next hole 26.

Each hole 26 is formed so as to pass through the opacifying layer 24, and optionally the appearance layer 22.

The laser 36 is configured, for example, to generate infrared laser radiation, i.e. with a wavelength in the infrared range.

The parameters for using the laser 36 are set to pierce each hole 26 through the opacifying layer 24, and possibly the appearance layer 22, in one or more laser pulses, to an adequate depth.

The parameters for using the laser 36 include the light frequency of the laser 36, the power of the laser 36 and the number of laser pulses generated to form each hole 26.

The parameters of use are chosen as a function of the material and thickness of the opacifying layer 24 and, where appropriate, as a function of the material and thickness of the appearance layer 22.

As illustrated in FIG. 4, in the case of a mask 18 disposed on the outer surface 14 of the substrate 12, each hole 26 is for example formed after applying the opacifying layer 24 and then the appearance layer 22, by forming each hole 26 through the appearance layer 22 and the opacifying layer 24.

Alternatively, in the case of a mask 18 disposed on the external surface 14 of the substrate 12, each hole 26 is formed, for example, after the opacifying layer 24 has been applied and before the appearance layer 22 has been applied. Each hole 26 thus passes through the opacifying layer 24 without passing through the appearance layer 22.

As illustrated in FIG. 5, in the case of a mask 18 disposed on the inner surface 16 of the substrate 12, each hole 26 is for example formed after applying the appearance layer 22 and then the opacifying layer 24, by forming each hole 26 through the opacifying layer 24 and optionally the appearance layer 22.

In one example, each hole 26 is formed through the opacifying layer 24 and the appearance layer 22.

In one example, each hole 26 is formed through the opacifying layer 24 without passing through the appearance layer 22. In this case, the parameters for using the laser 36 are set to form each hole 26 by passing through the opacifying layer 24 without passing through the appearance layer 22.

If necessary, the manufacturing process includes a step of applying a layer of protective coating 30.

As illustrated in FIG. 4, in the case of a mask 18 disposed on the outer surface 14 of the substrate 12, the protective coating layer 30 is applied to the mask 18, preferably after the holes 26 have been formed.

As illustrated in FIG. 5, in the case of a mask 18 disposed on the inner surface 16 of the substrate 12, the protective coating layer 30 is for example applied to the outer surface 14 of the mask 18, before or after depositing the mask on the inner surface 16 and before or after forming the holes 26 in the mask 18.

In one example, the application of the protective coating layer 30 comprises first depositing a primer layer, for example by spraying, and then depositing a varnish layer, for example by spraying.

The protective coating layer 30 is optionally heat treated to harden the varnish layer 28 and improve the adhesion of the primer layer 26 and the varnish layer to the mask 18 or the outer surface 14 of the substrate 12, as appropriate.

The lighting device 10 is then assembled as shown in FIG. 1 or FIG. 3. The substrate 12 faces the light source 20. For example, the assembly is fixed in a housing (not shown). The luminous device 10 is then fixed to the vehicle.

1. A vehicle lighting device comprising a translucent substrate, a mask overlying the substrate, the mask comprising an appearance layer and an opacifying layer, and a light source, the mask having a plurality of holes through the opacifying layer to allow light to pass through the mask when the light source is switched on, each hole having a diameter equal to or less than 0.40 mm, the holes being distributed so as to jointly form a light pattern when the light source is switched on.

2. The vehicle lighting device according to claim 1, wherein the light pattern is formed by at least 50 holes.

3. The vehicle lighting device according to claim 1, wherein the light pattern is formed by at least 100 holes.

4. The vehicle lighting device according to claim 1, wherein each hole has a diameter equal to or less than 0.30 mm.

5. The vehicle lighting device according to claim 1, wherein each hole has a diameter equal to or less than 0.20 mm.

6. The vehicle lighting device according to claim 1, wherein each hole has a diameter equal to or less than 0.10 mm.

7. The vehicle lighting device according to claim 1, wherein the distance between each hole and each other hole is equal to or greater than 0.20 mm.

8. The vehicle lighting device according to claim 1, wherein the distance between each hole and at least one other hole is equal to or less than 0.50 mm.

9. The vehicle lighting device according to claim 1, wherein the distance between each hole and at least one other hole is equal to or less than 0.40 mm.

10. The vehicle lighting device according to claim 1, wherein the mask covers an inner surface of the substrate or an outer surface of the substrate.

11. The vehicle lighting device according to claim 1, wherein the appearance layer is located in front of the opacifying layer.

12. The vehicle lighting device according to claim 1, wherein the holes extend through the appearance layer.

13. The vehicle lighting device according to claim 1, wherein the appearance layer is a colored paint.

14. The vehicle lighting device according to claim 1, wherein the opacifying layer is an opacifying paint.

15. A method of manufacturing the vehicle lighting device according to claim 1, comprising:
obtaining a substrate;
applying the appearance layer and the opacifying layer to the substrate; and
forming the plurality of holes in the opacifying layer using laser pulses generated by a laser.

16. The method according to claim 15, further comprising forming a plurality of holes in the appearance layer using laser pulses generated by a laser.
